(19) United States
(12) Patent Application Publication
(10) Pub. No.: US 2007/0109323 A1
(43) Pub. Date: May 17, 2007

(54) System and method for displaying map

(75) Inventor: Yasuo Nakashima, Hekinan-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/598,640

(22) Filed: Nov. 14, 2006

(30) Foreign Application Priority Data
Nov. 17, 2005 (JP) 2005-332997

(51) Int. Cl. G09G 5/00

(52) U.S. Cl. 345/661

(57) ABSTRACT

A map display system includes an operation detection unit for detecting a contact of an indication member with a window frame of a map, a window resizing unit for resizing the window frame according to a movement of the indication member, and a window restoring unit for restoring the window frame to an indication member pre-contact state when the indication member loses contact with the window frame. The window resizing unit maintains a display scale of the map in a course of resizing the window frame, and the window restoring unit adapts the display scale of the map in the window frame being restored to include at least a display area of the map before restoring the window frame.

### CROSS REFERENCE TO RELATED APPLICATION

This application is based on and claims the benefit of priority of Japanese Patent Application No. 2005-332997 filed on Nov. 17, 2005, the disclosure of which is incorporated herein by reference.

### FIELD OF THE INVENTION

The present invention generally relates to a map display system in a vehicle.

### BACKGROUND OF THE INVENTION

Conventionally, a map in a navigation system is zoomed in and out by switching the display scale on a display unit of the navigation system (refer to Japanese patent document JP-A-H05-216398). The navigation system in this disclosure has a touch panel on the display unit, and coordinates of a center position and the display scale of the map in the navigation system is respectively selected and determined based on the touch position and the number of touching operation in a predetermined period of time on the touch panel.

However, suitability of the display scale selected in the above-described manner in terms of inclusion of a desired position in the map can be evaluated only after displaying the map in the specified display scale. That is, a user of the navigation system has to re-scale the map when the map displayed in the specified display scale does not include the desired position.

### SUMMARY OF THE INVENTION

In view of the above and other problems, a map display system in the present disclosure provides an intuitive operation method for changing the display scale of the map. More practically, the map display system allows the user to dynamically control the display scale when the user moves a pointer along a frame of the display unit. In this manner, the user can control the display scale of the map by confirming the display content of the map on the display unit.

In one aspect of the present disclosure, the map display system for use in a vehicle includes an operation detection unit for detecting a contact of an indication member with a window frame of a map, a window resizing unit for resizing the window frame according to a movement of the indication member, and a window restoring unit for restoring the window frame to an indication member pre-contact state when the indication member loses contact with the window frame. The window resizing unit maintains a display scale of the map in a course of resizing the window frame, and the window restoring unit adapts the display scale of the map in the window frame being restored to include at least a display area of the map before restoring the window frame. In this manner, the display scale of the map in the window frame can be intuitively controlled by operating the window frame on the display unit.

In another aspect of the present disclosure, the map display system includes the operation detection unit for detecting a contact of the indication member with the window frame of the map screen and an auxiliary information screen, the window resizing unit, and the window restoring unit. The window resizing unit maintains the display scale of the map in the map screen and a size of the auxiliary information screen in the course of resizing the window frame, and the window restoring unit adapts the display scale of the map in the window frame being restored to include at least a display area of the map before restoring the window frame. In this manner, the display scale of the map in the window frame can be intuitively controlled by operating the window frame on the display unit.

In yet another aspect of the present disclosure, the map display system detects an operation speed of the window frame by the indication member, and controls the display scale of the map in the map screen according to the operation speed of the window frame and the size of the window frame. In this manner, the display scale of the map in the window frame can be intuitively controlled. In addition, the size of the auxiliary information screen can be maintained in the course of display scale change.

Further, as still yet another aspect of the present disclosure, the window resizing unit changes the display scale of the map image information in proportion to the speed of the movement of the indication member, thereby enabling an intuitive control of the display scale of the map in the map screen.

Furthermore, as still yet another aspect of the present disclosure, the window resizing unit dynamically changes a screen division ratio of the map screen relative to a stationary position of a self-vehicle mark, thereby enabling the intuitive control of map display area.

Furthermore, as still yet another aspect of the present disclosure, the window resizing unit maintains a screen division ratio of the map screen relative to a position of a self-vehicle mark by adaptively changing the position of the self-vehicle mark, thereby maintaining the self-vehicle mark at the same point on the map.

Furthermore, as still yet another aspect of the present disclosure, the map display system includes a display scale restoring unit for restoring the map image information to the display scale before adaptation by the window restoring unit when a predetermined amount of time has elapsed after the window frame is restored to the frame size before detection of the contact of the indication member with the window frame. In this manner, the display scale of the map returns to a pre-resizing state, thereby eliminating inconvenience of display scale restoration.

Furthermore, as still yet another aspect of the present disclosure, the operation detection unit maintains an aspect ratio of the window frame by not using the window restoring unit when the indication member stops at a same position for at least a predetermined amount of time while having the contact with the window frame. In this manner, the aspect ratio of the window frame can be fixed as it is.

The aspects of the present disclosure described above may be provided as a map display method implemented by using an operation process in the navigation system or in a similar apparatus. Therefore, each of the above described aspects can also be realized as operation processes of the navigation system.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a navigation device in a first embodiment of the present disclosure;

FIG. 2 shows a flowchart of map display scale changing processing of the navigation device in the first embodiment;

FIG. 3 shows an illustration of a normal screen of the navigation device in the first embodiment;

FIG. 4 shows an illustration of a scale up/scale down operation of a display window in the first embodiment;

FIG. 5 shows another illustration of a scale up/scale down operation of a display window in the first embodiment;

FIG. 6 shows yet another illustration of a scale up/scale down operation of a display window in the first embodiment;

FIG. 7 shows an illustration of a scale up/scale down operation of a display window in a second embodiment;

FIG. 8 shows another illustration of a scale up/scale down operation of a display window in the second embodiment; and

FIG. 9 shows a flowchart of map display scale changing processing in a third embodiment.

### DETAILED DESCRIPTION OF THE PREFERRED EMBODIMENTS

The present invention will be described in detail with reference to various embodiments, in which the same reference numerals designate same or similar members.

### First Embodiment

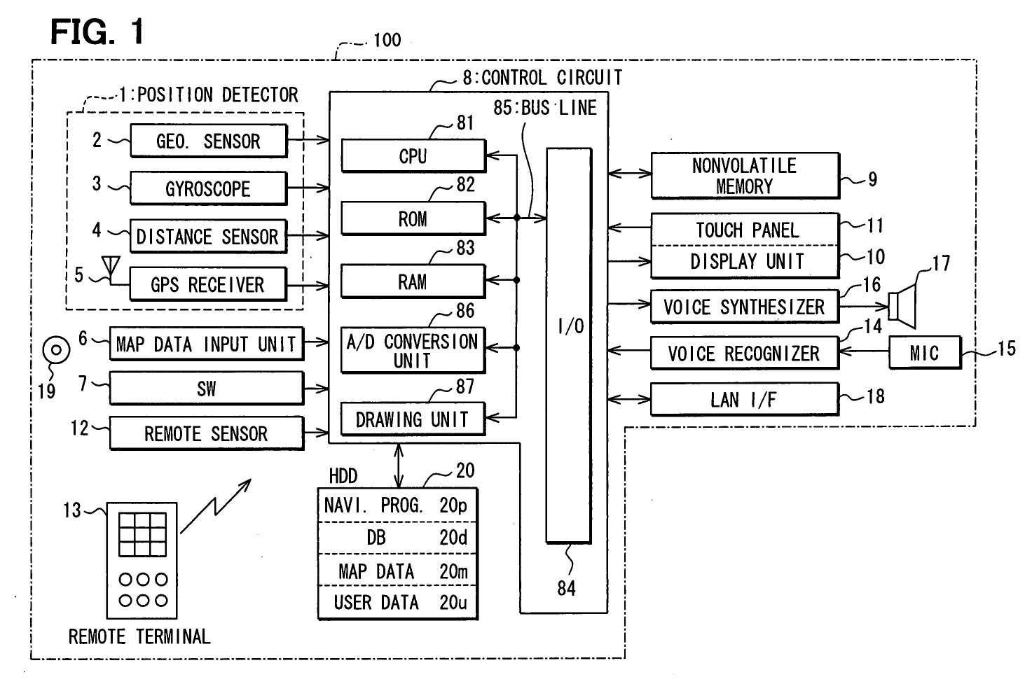

FIG. 1. is a circuit block diagram showing a navigation device 100 according to a first embodiment of the invention. The main part of the navigation device 100 according to the first embodiment comprises a position detector 1, a map data input unit 6, an operating switch group 7, a control circuit 8, a non-volatile memory 9, a display unit 10, a touch panel 11, a remote control sensor 12, a remote controller terminal 13, a voice recognizing unit 14, a microphone 15, a voice synthesizing circuit 16, a speaker 17, LAN (local Area Network) I/F (Interface) 18, a storage medium 19, and a hard disc drive (HDD) 20.

The position detector 1 has a well-known geomagnetic sensor 2, a gyro scope 3 for detecting the rotational angular velocity of a vehicle, a range sensor 4 for detecting the travel distance of the vehicle, and a GPS (Global Positioning System) receiver 5 for detecting the position of the vehicle on the basis of electrical waves from a satellite, and calculates the absolute coordinate on the earth. These sensors 2, 3, 4 and 5 have errors whose properties are different from one another, respectively, and thus the position detector 1 is designed to be used while complemented by plural sensors. In accordance with the precision, the position detector 1 may be constructed by some of the sensors described above, and further a steering rotation sensor, a wheel sensor for each driving wheel, that is, for example, a vehicle speed sensor or the like may additionally be used.

The map data input unit 6 is a storage medium reading device for reading data from a storage medium 19 such as CD-ROM (Compact Disk-Read Only Memory), DVD (Digital Versatile Disk) or the like.

The touch panel 11 or mechanical switch which is designed integrally with the display unit 10 is used as the operating switch group 7.

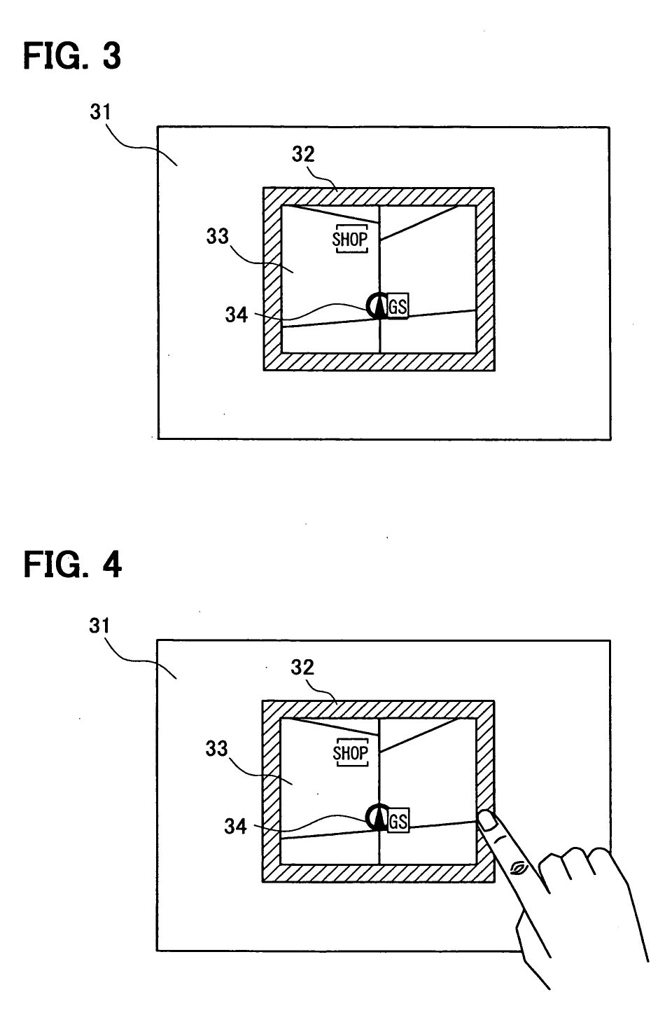

The control circuit 8 acquires map image information around the absolute coordinate of the position detector 1 to display a display window frame 32 on the display screen 31 of the display unit 10, and also display a map screen 33 and a mark 34 of the vehicle in the display window frame 32 (see FIG. 3). That is, the control circuit 8 serves as operation detecting means, display window frame deforming means, display window frame restoring means and display scale restoring means. The control circuit 8 is normally constructed by a computer, and it comprises a well-known CPU (central Processing Unit) 81, a ROM (Read Only Memory) 82, a RAM (Random Access Memory) 83, an I/O (Input/Output) 84, an A/D (Analog/Digital) converter 86, a drawing portion 87 and a bus line 85 for connecting these elements.

The CPU 81 executes control on the basis of a navigation program (hereinafter abbreviated to navi-program) 20p and data stored in the HDD 20. The CPU 81 controls reading/writing of data from/into the HDD 20.

The ROM 82 is stored the minimum program required to start the navigation device 100. Furthermore, the ROM 82 may be stored a program to perform the required and minimum program out of the navigation function.

The RAM 83 is a memory for temporarily loading commands and data in connection with execution or processing of the programs such as the navi-program 20p, etc. by the CPU 81.

The A/D converter 86 contains a well-known A/D converter, and converts analog data input from the position detector 1 or the like to the control circuit 8 into digital data which can be operated by the CPU 81.

The drawing portion 87 generates display frame data for the display unit 1 from display data and display color data stored in the HDD 20 or the like.

The non-volatile memory 9 is constructed by a rewritable semiconductor memory. such as EEPROM (Electrically Erasable & Programmable Read Only Memory), a flash memory or the like, and stored with information and data required to operate the navigation device 100. The storage content of the non-volatile memory 9 is held even when an accessory switch of the vehicle is set to OFF state, that is, the navigation device 100 is set to OFF state. The information and the data required to operate the navigation device 100 may be stored in the HDD 20 in place of the non-volatile memory 9. Furthermore, the information and the data required to operate the navigation device 100 may be stored while shared to the non-volatile memory 9 and the HDD 20.

The display unit 10 is constructed by a well-known color liquid crystal display unit, and contains a dot matrix LCD (Liquid Crystal Display) and a driver circuit (not shown) for performing LCD display control. The driver circuit adopts an active matrix driving system in which a transistor is provided for every pixel and a target pixel can be surely turned on or off, and performs display on the basis of a display instruction and display frame data transmitted from the control circuit 8. An organic EL (Electroluminescence) display unit, a plasma display unit or the like may be used as the display unit 10.

The touch panel 11 is an input device secured to the display screen of the display unit 10, and transmits to the control circuit 8 the coordinate value of a position where a user touches. As the touch panel 11 is broadly used a so-called resistance film type in which an electrical circuit is wired in the X-axis direction and the Y-axis direction through a gap called as a spacer between a glass board and a transparent film on the screen of the display unit 10, when the user touches the film by his/her finger, the wire at the pressed portion is short-circuited, and a voltage value is varied, thereby detecting the touch position as a two-dimensionally coordinate value (X,Y). An indication member to the touch panel 11 may be other members such as a touch pen, etc. in addition to the finger of the user. Furthermore, a so-called electrostatic capacitance type may be used. Furthermore, in place of the mechanical switch, a pointing device such as a mouse, a cursor or the like may be used.

The remote control sensor 12 is a reception unit for receiving electric waves from the remote control terminal 13.

The remote control terminal 13 has plural input buttons, and transmits the instruction corresponding to the operated input button to the remote control sensor 12 in a wireless mode by electric waves or infrared ray.

The voice recognizing unit 14 processes a voice signal input from the microphone 15 by a voice recognizing technique such as a well-known hidden Markov model or the like, and converts the voice signal to the operating command corresponding to the result.

The microphone 15 is voice input means for enabling the user to input various instructions through the voice recognizing unit 14 to the control circuit 8.

The voice synthesizing circuit 16 converts digital voice data stored in the non-volatile memory 9 or the HDD 20 to an analog voice signal on the basis of the instruction of the navi-program 20p, and outputs the analog voice signal thus converted. As a method of synthesizing voice is known a method of recording edition system in which voice waveforms are directly accumulated or encoded and accumulated, and spliced as occasion demands.

The speaker 17 is connected to the voice synthesizing circuit 16, and generates voices on the basis of the analog voice signal output from the voice synthesizing circuit 16.

The LAN I/F 18 is an interface circuit for communicating data with another in-vehicle mount equipment or a sensor through in-vehicle LAN (not shown). Data may be taken in from the vehicle speed sensor through the LAN I/F 18, or the LAN I/F 18 may connect to ETC in-vehicle unit (not shown) or the like.

The storage medium 19 is a recording medium for storing the navi-program 20p, database 20d, map data 20m, etc., and CD-ROMs or DVDs are generally used as the storage medium 19 for accommodating the data with a certain volume. However, other storage medium such as a memory card or the like may be used, for example. Furthermore, data may be downloaded through an external network.

In the HDD 20 are stored the navi-program 20p, so-called map matching data to enhance the precision of the position detection, and the map data 20m containing road data representing connections of roads, etc. The map data 20m stores predetermined map image information for display, and also stores road network information containing link information, node information, etc. The link information is predetermined section information constituting each road, and it is constructed by position coordinates, the distance, the time required, the road width, the number of lanes, the speed limit, etc. The node information is information for defining cross points (fork roads), etc., and it is constructed by the position coordinates, the number of right and left turn lanes, a connection target road link, etc. Data indicating allowance or prohibition of passage, etc. are set in inter-link connection information.

Auxiliary information for route guidance, amusement information and other data can be written in the HDD 20 by the user himself/herself, and stored as user data 20u. The contents of these user data 20u can be rewritten by operating the operating switch group 7, the touch panel 11 and the remote control terminal 13 or inputting voices from the microphone 15. Furthermore, data and various kinds of information required to operate the navigation device 100 may be stored as a database 20d.

Additional and/or renewal data can be provided for the data on the navi-program 20p, the database 20d, the map data 20m and the user data 20u from the storage medium 19 through the map data input unit 6.

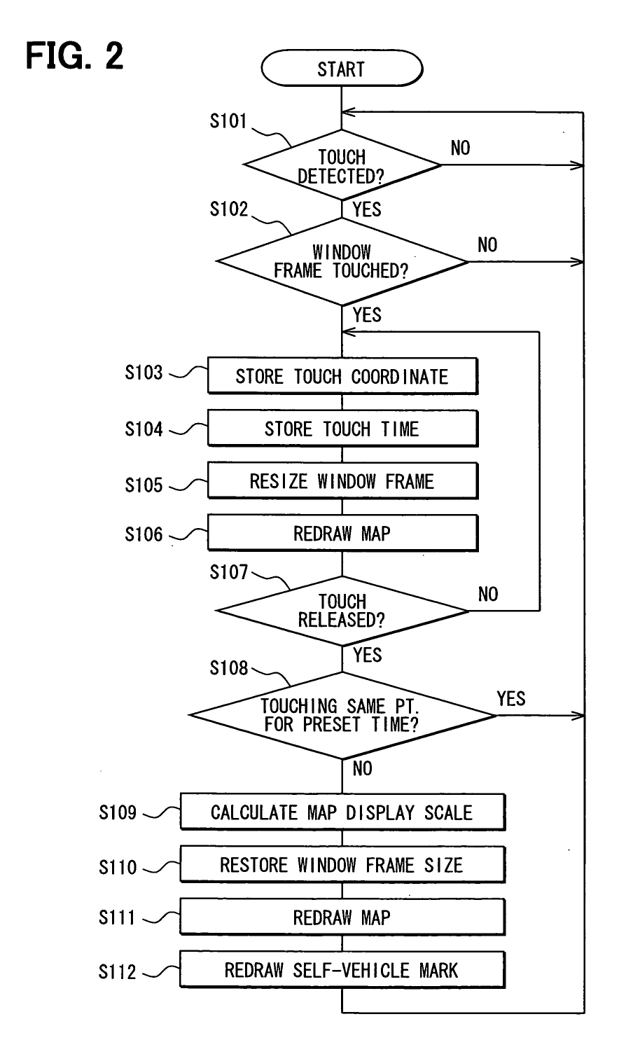

FIG. 2 is a flowchart showing the display scale changing processing in the navigation device 100 according to the first embodiment. The display scale changing processing is contained in the navi-program 20p, and it is repetitively executed together with other programs of the navi-program 20p.

FIG. 3 shows a display screen 31 displayed on the display unit 10. The display window frame 32 is provided at the center on the display screen 31, and the inside of the display window frame 32 serves as the map screen 33. Map image information is drawn on the map screen 33, and the vehicle mark 34 is further displayed while superposed on the map image information displayed on the map screen 33. The display window frame 32 is designed in a rectangular frame shape and each side has a predetermined width.

FIGS. 4 to 6 are diagrams showing the sequential steps of scale-up/scale-down operation of the display window frame 32 in the navigation device 100.

Next, the operation of the navigation device 100 according to the first embodiment thus constructed will be described with reference to FIGS. 1 to 6.

In the navigation device 100, the control circuit 8 starts the navi-program 21p by the CPU 81, and displays the display screen 31 (normal screen) as shown in FIG. 3 on the display unit 10. In the example of FIG. 3, it is assumed that the user's vehicle (hereinafter referred to as the self-vehicle) travels on a road extending in parallel to an arterial road which is not displayed on the map display information of the map screen 33 in order to avoid traffic jam on the arterial road.

It is assumed that under this travel state, the user wants to return to the arterial road again at a point where the traffic jam of the arterial road is eliminated and feels to know both of the statuses of the present traveling road and the arterial road. Therefore, the user touches the display window frame 32 of the display screen 31 by a finger as shown in FIG. 4, and moves (displaces) the finger to the locating position of map image information which the user wants to see while keeping the finger touch.

At this time, the control circuit 8 detects that the display screen 31 of the display unit 10 is touched through the touch panel 11 (S101 of FIG. 2: YES), and detects that the position of the touched coordinate (touch coordinate) is the display window frame 32 (S102 of FIG. 2: YES).

Subsequently, the touch coordinate is stored (S103 of FIG. 2) in the control circuit 8, the time of touching is stored (S104 of FIG. 2), and the display window frame 32 is scaled up or scaled down (S105 of FIG. 2). Specifically, one side of the display window frame 32 at which the touch coordinate is located is moved in accordance with the variation of the touch coordinate which follows the movement of the finger, thereby scaling up or scaling down the display window frame 32.

Subsequently, the control circuit 8 re-draws the map image information on the map screen 33 in the scale-up or scale-down display window frame 32 (S106 of FIG. 2). Accordingly, when the display window frame 32 is scaled up, the range of the map image information which has not been displayed on the map screen 33 till now is displayed.

Subsequently, the control circuit 8 determines whether the touch of the finger to the display window frame 32 is released (S107 of FIG. 2). If the touch of the finger to the display window frame 32 is not released (S107 of FIG. 2: NO), the control is returned to step S103 to repeat the steps S103 to S107.

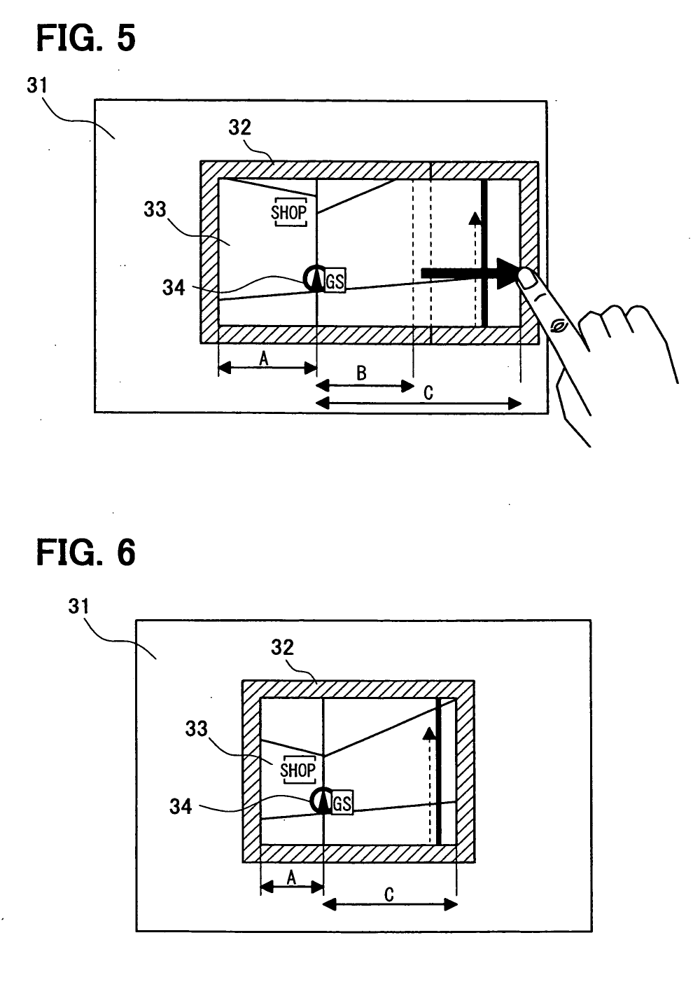

By repeating the steps S103 to S107, the display screen 33 of the display window frame 32 is temporarily enlarged to the right side as shown in FIG. 5 in accordance with the movement of the finger under the state that the user's finger is kept in touch with the display window frame 32, and the portion of the map image information which has not yet been viewed is also displayed. At this time, the display position of the self-vehicle mark 34 on the display screen 33 is originally displayed at the position where the screen separation ratio A:B (normally, A=B) is satisfied with respect to the width A and the width B. However, after the scale-up/scale-down operation of the display window frame 32 is carried out, the self-vehicle mark 34 is displayed at the position where the screen separation ratio A:C is satisfied with respect to the width A and the width C.

As shown in FIG. 5, when a desired portion of the map image information (for example, arterial road) is displayed on the map screen 33 in the display window frame 32, the user separates the finger from the display window frame 32 to thereby complete the scale-up/scale-down of the display window frame 32.

When the scale-up/scale-down operation of the display window frame 32 is completed, the control circuit 8 detects that the touch of the finger to the display window frame 32 is released (S107 of FIG. 2: YES), and refers to the stored touch coordinate and the time to determine whether the state that the finger is touching the display window frame 32 with its position not being moved continues for a predetermined time (for example, for 2 seconds) or more (S108 of FIG. 2).

If the state that the finger is touching the display window frame 32 with its position not being moved continues for the predetermined time (for example, 2 seconds) or more (S108 of FIG. 2: YES), it means an indication of user's intention that the user wants to stop under the present state of the display window frame 32. Therefore, the control circuit 8 returns the control to the step S101 while keeping the present display state. For example, as shown in FIG. 5, when the finger is not immediately separated after the movement of the finger is finished, but it is pressed for a while and then separated, the display window frame 32 is not scaled down as shown in FIG. 6, but the display window frame 32 keeps the shape and size at that time point (that is, the aspect ratio (the ratio between width and height) of the display window frame 32 is fixed to the state at that time point), and the map image information displayed on the map screen 33 in the display window frame 32 is kept to be displayed in the display scale at that time point.

On the other hand, if the state that the finger is not moved while kept in touch with the display window frame 32 does not continue for the predetermined time (for example, 2 seconds) or more (S108 of FIG. 2: NO), it means an indication of user's intention that the display scale of the map image information is changed so that the display range of the map image information displayed on the map screen 33 in the display window frame 32 is contained, and thus the control circuit 8 calculates the display scale of the map image information displayed on the map screen 33 in the display window frame 32 (S109 of FIG. 2). Specifically, when the scale-up or scale-down display window frame 32 is returned to the size (the size of FIG. 3) before the touch of the finger is detected, the display scale of the map image information is calculated so that the whole display range of the map image information displayed on the map screen 33 at the present time is displayed on the map screen 33 in the display window frame 32 of the returned size.

Subsequently, the control circuit 8 restores the size of the display window frame 32 to the size before the touch of the finger to the display window frame 32 is detected (S110 of FIG. 2) as shown in FIG. 6. That is, the display window frame 32 is returned to the same size as shown in FIG. 3.

Subsequently, as shown in FIG. 6, the control circuit 8 re-draws the map image information on the map screen 33 in the display window frame 32 in the display scale calculated previously (S111 of FIG. 2). In this case, all the display range of the map image information displayed on the map screen 33 in FIG. 5 is displayed on the map screen 33 in the display window frame 32 having the restored size. As a result, when the scale-up operation of the display window frame 32 is carried out, a broader range of map image information is displayed on the map screen 33 in the display window frame 32 having the same size, and thus the display scale of the map image information is reduced. Accordingly, when the scale-down operation of the display window frame 32 is carried out, a narrower display range of map image information is displayed on the map screen 33 in the display window frame 32 having the same size, so that the display scale of the map image information is increased.

Subsequently, the control circuit 8 re-draws the self-vehicle mark 34 on the map screen 33 in the display window frame 32 (S112 of FIG. 2). The reason for this is as follows. In the scale-up/scale-down operation of the display window frame 32, the display position of the self-vehicle mark 34 is fixed on the map screen 33 and the screen separation ratio between the right and left sides of the self-vehicle mark 34 is dynamically varied from A:B to A:C. In this case, if the map image information is re-drawn while the screen separation ratio A:C is kept, the position of the self-vehicle mark 34 on the map screen 33 is varied, and thus it is necessary to re-draw the self-vehicle mark 34.

According to the first embodiment, in connection with the movement of the finger touched to the display window frame 32, the display scale of the map image information can be freely set in an intuitive manner until user's desired map image information is displayed.

In the navigation device 100 according to the first embodiment, the operation when the display scale is changed in the width direction (right and left direction) of the display window frame 32 has been described. However, it is to be noted that the same operation is carried out in the height direction (vertical direction).

Furthermore, according to the navigation device 100 of the first embodiment, in the scale-up/scale-down operation of the display window frame 32 shown in FIGS. 3 to 6, the display position of the self-vehicle mark 34 is fixed, and the screen separation ratio is dynamically varied from A:B to A:C. However, the display position of the self-vehicle mark 34 may be dynamically moved so that the screen separation ratio A:B is maintained.

Still furthermore, according to the navigation device 100 of the first embodiment, as shown in FIG. 5, the finger is touched to the right side of the display window frame 32 and moved rightwards, whereby the right side of the display window frame 32 is moved rightwards (in connection with this movement, the upper side and the lower side are extended). However, the right and left sides of the display window frame 32 may be moved rightwards or leftwards together, or the right, left, upper and lower sides of the display window frame 32 may be moved rightwards, leftwards, upwards or downwards together. In other words, the display window frame 32 is panned toward a right/left/upper/lower direction with its aspect ration maintained.

Furthermore, the change of the display scale from the normal screen of FIG. 3 to the display scale changing operation completion screen shown in FIG. 6 may be set to a temporary operation, and after a predetermined time elapses, the screen may be automatically returned to the normal screen in FIG. 3 that is being displayed before the finger touch is detected (the display scale before the finger touch is detected).

### Second Embodiment

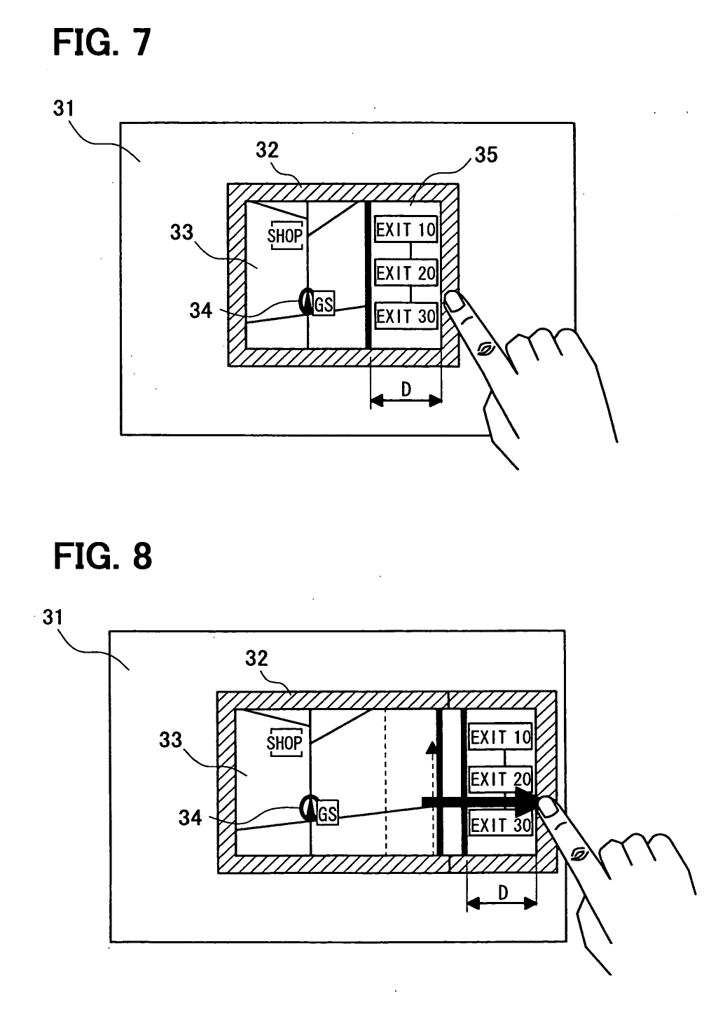

When the map screen 33 and the auxiliary information screen 35 are divisionally displayed in the display window frame 32 as shown in FIG. 7, the auxiliary information screen 35 other than the map screen 33 may be set so that the width size D thereof is not varied.

Although the detailed description is omitted, according to the navigation device 100 of a second embodiment of the present invention, when the finger is moved while touched to the display window frame 32 as shown in FIG. 8, the width size D of the auxiliary information screen 35 is not varied, and only the width size of the map screen 33 is enlarged.

Other portions which are not particularly described are constructed in the same manner as the corresponding portions of the navigation device 100 of the first embodiment shown in FIGS. 1 to 6, and thus the detailed description is omitted.

According to the navigation device 100 of the second embodiment, an additional effect that only the width size of the map screen 33 can be scaled up and scaled down without scaling up or scaling down the width size D of the auxiliary information screen 35 is achieved besides the effect of the navigation device 100 of the first embodiment.

### Third Embodiment

When the finger is moved while touched to the display window frame 32 in FIG. 5, the display scale of the map image information may be changed so that map image information of farther places can be displayed in the act of moving the finger as the moving speed of the finger is higher.

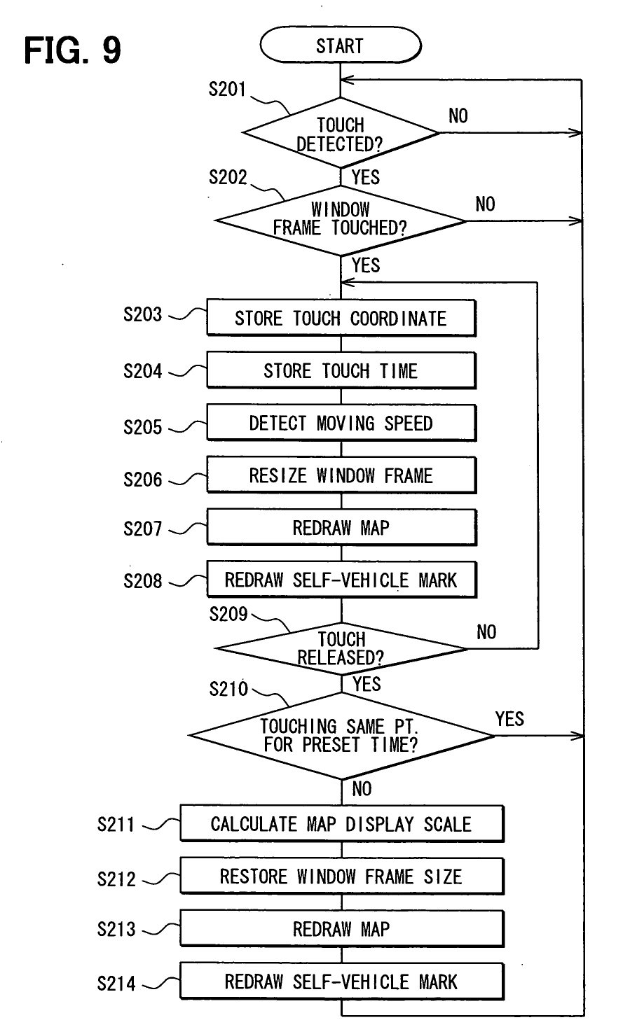

FIG. 9 is a flowchart showing the map display scale changing processing in the navigation device 100 in a third embodiment of the present invention. The map display scale changing processing is contained in the navi-program 20p, and it is repetitively executed together with the other programs.

Portions which are not particularly described are constructed in the same manner as the corresponding portions of the navigation device 100 according to the first embodiment shown in FIGS. 1 to 6, and thus the detailed description is omitted.

Next, the operation of the navigation device 100 according to the third embodiment thus constructed will be described by concentrating on the difference from the operation of the navigation device 100 according to the first embodiment.

When the user touches the display window frame 32 of the display screen 31 by his/her finger and moves the finger to a locating position of map image information which the user wants to see while touching the finger to the display window frame 32, the control circuit 8 detects the touch on the display screen 31 through the touch panel 11 (S201 of FIG. 9: YES), and further detects that the position of the touched coordinate (touch coordinate) is the display window frame 32 (S202 of FIG. 9: YES).

Subsequently, the control circuit 8 stores the touch coordinate (S203 of FIG. 9), stores the time of touching (S204 of FIG. 9), and detects the moving speed of the finger on the basis of the touch coordinate and the time thus stored (S205 of FIG. 9).

Subsequently, the control circuit 8 moves one side of the display window frame 32 at the locating position of the touch coordinate in accordance with the variation of the touch coordinate which is caused by the movement of the finger, and scales up or scales down the display window frame 32 (S206 of FIG. 9).

Subsequently, the control circuit 8 re-draws the map image information on the map screen 33 in the scale-up or scale-down display window frame 32 (S207 of FIG. 9). At this time, the map image information is re-drawn so that a broader range of map image information is re-drawn as the previously detected moving speed of the finger is higher.

Subsequently, the control circuit 8 re-draws the self-vehicle mark 34 on the map screen 33 in the display window frame 32 (S208 of FIG. 9). In the re-draw operation, a broader range of the map image information is re-drawn on the map screen 33 in the scale-up/down of the display window frame 32 in proportion to an increased moving speed of the finger, and thus the position of the self-vehicle mark 34 on the map screen 33 is varied. Therefore, the self-vehicle mark 34 has to be re-drawn.

Subsequently, the control circuit 8 judges whether the touch of the finger to the display window frame 32 is released (S209 of FIG. 9). If the touch of the finger to the display window frame 32 is not released (S209 of FIG. 9: NO), the control is returned to step S203 to repeat steps S203 to S209.

When a desired portion (for example, an arterial road) of the map image information is displayed on the map screen 33 in the display window frame 32, the user separates his/her finger from the display window frame 32 to complete the scale-up/scale-down of the display window frame 32.

When the scale-up/scale-down operation of the display window frame 32 is completed, the control circuit 8 detects that the touch of the finger to the display window frame 32 is released (S209 of FIG. 9: YES), and refers to the stored touch coordinate and time to determine whether the state that the finger is touching to the display window frame 32 with its position not being moved continues for a predetermined time (for example, 2 seconds) or more (S210 of FIG. 9).

If the state that the touch of the finger to the display window frame 32 without finger movement continues for the predetermined time (for example, 2 seconds) or more (S210 of FIG. 9: YES), the control circuit 8 returns the control to the step S201 with keeping the present display state.

On the other hand, if the state that the touch of the finger to the display window frame 32 without finger movement does not continue for the predetermined time (for example, 2 seconds) or more (S210 of FIG. 9: NO), the control circuit 8 calculates the display scale of the map image information displayed on the map screen 33 in the display window frame 32 so that when the scale-up or scale-down display window frame 32 is returned to the size (the size of FIG. 3) that is being displayed before the touch of the finger to the display window frame 32 is detected, all the display range of the map image information displayed on the map screen 33 at the present time is displayed on the map screen 33 in the display window frame 32 having the returned size (S211 of FIG. 9).

Subsequently, the control circuit 8 restores the size of the display window frame 32 to the size that is being displayed before the touch of the finger to the display window frame 32 is detected (S212 of FIG. 9).

Subsequently, the control circuit 8 re-draws the map image information on the map screen 33 in the display window frame 32 in the previously calculated display scale (S213 of FIG. 9).

Subsequently, when the map image information is re-drawn, the position of the self-vehicle mark 34 on the map screen 33 is varied. Therefore, the control circuit 8 re-draws the self-vehicle mark 34 on the map screen 33 in the display window frame 32 (S214 of FIG. 9).

According to the third embodiment, the map screen 33 is displayed as the display window frame 32, and the size of the display window frame 32 is operated at a certain speed, whereby the display scale of the map image information displayed on the map screen 33 is changeable in accordance with the size of the display window frame 32 and the operating speed. Therefore, the effect that the display scale of the map image information displayed on the map screen 33 can be freely set by the intuitive operating method is achieved.

### Fourth Embodiment

When the map screen 33 and the auxiliary information screen 35 are divisionally displayed in the display window frame 32, in the navigation device 100 of the third embodiment, the auxiliary information screen 35 other than the map screen 33 can be displayed so that the width size D thereof is not varied as in the case of the navigation device 100 of the second embodiment.

Although the detailed description is omitted, in the navigation device 100 of a fourth embodiment of the present invention, when the finger is moved while touching on the display window frame 32, the width size D of the auxiliary information screen 35 is not varied, and only the width size of the map screen 33 is enlarged.

Other portions which are not particularly described are constructed in the same manner as the corresponding portions of the navigation device 100 of the first embodiment shown in FIGS. 1 to 6 and the navigation device 100 of the third embodiment shown in FIGS. 7 and 8, and thus the detailed description is omitted.

According to the navigation device 100 of the fourth embodiment, the effect that only the width size of the map screen 33 can be scaled up and scaled down without scaling up and scaling down the width size D of the auxiliary information screen 35 is achieved.

Although the present disclosure has been fully described in connection with the preferred embodiments thereof with reference to the accompanying drawings, it is to be noted that various changes and modifications will become apparent to those skilled in the art.

For example, the navigation device 100 is described as an on-vehicle device in the above-described embodiment, the navigation device of the present disclosure may also be implemented on a cellular phone, a PDA (Person al Digital Assistant), a notebook computer, or various kinds of portable devices.

Further, the indication member that touches the display window frame 32 may be different from the finger of the user. That is, the indication member may be a touch pen or other similar device.

Such changes and modifications are to be understood as being within the scope of the present invention as defined by the appended claims.

What is claimed is:

1. A map display system having a touch panel in a display unit comprising:
a window frame of a map screen;
an operation detection unit for detecting a contact of an indication member with the window frame;
a window resizing unit for resizing the window frame according to a movement of the indication member in contact with the window frame, wherein the window resizing unit maintains a display scale of map image information in the map screen in a course of resizing; and
a window restoring unit for restoring the window frame to a frame size before detection of the contact of the indication member when loss of the contact of the indication member with the window frame is detected, wherein the window restoring unit adapts the display scale of the map image information in the window frame being restored to include at least a display area of the map image information before restoration of the window frame.

2. A map display system having a touch panel in a display unit comprising:
a window frame of a map screen and an auxiliary information screen;
an operation detection unit for detecting a contact of an indication member with the window frame;
a window resizing unit for resizing the window frame according to a movement of the indication member in contact with the window frame, wherein the window resizing unit maintains a display scale of map image information in the map screen and a size of the auxiliary information screen in a course of resizing; and
a window restoring unit for restoring the window frame to a frame size before detection of the contact of the indication member when loss of the contact of the indication member with the window frame is detected, wherein the window restoring unit adapts the display scale of the map image information in the window frame that is being restored to include at least a display area of the map image information before restoration of the window frame without changing the size of the auxiliary information screen.

3. A map display system having a touch panel in a display unit comprising:
a window frame of a map screen;
an operation detection unit for detecting a contact of an indication member with the window frame;
a window resizing unit for resizing the window frame according to a speed of a movement of the indication member in contact with the window frame, wherein the window resizing unit changes a display scale of map image information in the map screen while resizing the window frame; and
a window restoring unit for restoring the window frame to a frame size before detection of the contact of the indication member when loss of the contact of the indication member with the window frame is detected, wherein the window restoring unit adapts the display scale of the map image information in the window frame that is being restored to include at least a display area of the map image information before restoration of the window frame.

4. A map display system having a touch panel in a display unit comprising:
a window frame of a map screen and an auxiliary information screen;
an operation detection unit for detecting a contact of an indication member with the window frame;
a window resizing unit for resizing the window frame according to a speed of a movement of the indication member in contact with the window frame, wherein the window resizing unit changes, in a course of resizing, a display scale of map image information in the map screen without changing a size of the auxiliary information screen; and
a window restoring unit for restoring the window frame to a frame size before detection of the contact of the indication member when loss of the contact of the indication member with the window frame is detected, wherein the window restoring unit adapts the display scale of the map image information in the window frame that is being restored to include, without changing the size of the auxiliary information screen, at least a display area of the map image information before restoration of the window frame.

5. The map display system as in claim 3,
wherein the window resizing unit changes the display scale of the map image information in proportion to the speed of the movement of the indication member.

6. The map display system as in claim 1,
wherein the window resizing unit dynamically changes a screen division ratio of the map screen relative to a stationary position of a self-vehicle mark.

7. The map display system as in claim 1,
wherein the window resizing unit maintains a screen division ratio. of the map screen relative to a position of a self-vehicle mark by adaptively changing the position of the self-vehicle mark.

8. The map display system as in claim 1 further comprising:
a display scale restoring unit for restoring the map image information to the display scale before adaptation by the window restoring unit when a predetermined amount of time has elapsed after the window frame is restored to the frame size before detection of the contact of the indication member with the window frame.

9. The map display system as in claim 1,
wherein the operation detection unit maintains an aspect ratio of the window frame by not using the window restoring unit when the indication member stops at a same position for at least a predetermined amount of time while having the contact with the window frame.

10. A method for displaying a map on a navigation system having a touch panel in a display unit comprising:
providing a window frame of a map screen;
detecting a contact of an indication member with the window frame;
resizing the window frame according to a movement of the indication member in contact with the window frame while maintaining a display scale of map image information in the map screen in a course of resizing; and
restoring the window frame to a frame size before detection of the contact of the indication member when loss of the contact of the indication member with the window frame is detected while adapting the display scale of the map image information in the window frame being restored for including at least a display area of the map image information before restoration of the window frame.

11. A method for displaying a map on a navigation system having a touch panel in a display unit comprising:
providing a window frame of a map screen and an auxiliary information screen;
detecting a contact of an indication member with the window frame;
resizing the window frame according to a movement of the indication member in contact with the window frame while maintaining a display scale of map image information in the map screen and a size of the auxiliary information screen in a course of resizing; and
restoring the window frame to a frame size before detection of the contact of the indication member when loss of the contact of the indication member with the window frame is detected while adapting the display scale of the map image information in the window frame that is being restored for including at least a display area of the map image information before restoration of the window frame without changing the size of the auxiliary information screen.

12. A method for displaying a map on a navigation system having a touch panel in a display unit comprising:
providing a window frame of a map screen;
detecting a contact of an indication member with the window frame;
resizing the window frame according to a speed of a movement of the indication member in contact with the window frame while changing a display scale of map image information in the map screen; and
restoring the window frame to a frame size before detection of the contact of the indication member when loss of the contact of the indication member with the window frame is detected while adapting the display scale of the map image information in the window frame that is being restored for including at least a display area of the map image information before restoration of the window frame.

13. A method for displaying a map on a navigation system having a touch panel in a display unit comprising:
providing a window frame of a map screen and an auxiliary information screen;
detecting a contact of an indication member with the window frame;
resizing the window frame according to a speed of a movement of the indication member in contact with the window frame while changing, in a course of resizing, a display scale of map image information in the map screen without changing a size of the auxiliary information screen; and
restoring the window frame to a frame size before detection of the contact of the indication member when loss of the contact of the indication member with the window frame is detected while adapting the display scale of the map image information in the window frame that is being restored for including, without changing the size of the auxiliary information screen, at least a display area of the map image information before restoration of the window frame.

14. The method as in claim 12,
wherein a change of the display scale of the map image information is in proportion to the speed of the movement of the indication member.

15. The method as in claim 10,
wherein resizing the window frame dynamically changes a screen division ratio of the map screen relative to a stationary position of a self-vehicle mark.

16. The method as in claim 10,
wherein resizing the window frame maintains a screen division ratio of the map screen relative to a position of a self-vehicle mark by adaptively changing the position of the self-vehicle mark.

17. The method as in claim 10 further comprising:
restoring the map image information to the display scale before adaptation when a predetermined amount of time has elapsed after the window frame is restored to the frame size before detection of the contact of the indication member with the window frame.

18. The method as in claim 10,
wherein an aspect ratio of the window frame is maintained by not restoring the window frame when the indication member stops at a same position for at least a predetermined amount of time while having the contact with the window frame.
